(19) United States
(12) Patent Application Publication
(10) Pub. No.: US 2022/0172649 A1
(43) Pub. Date: Jun. 2, 2022

(54) PROTECTIVE EXTERIOR LID LINER FOR A CHEST FREEZER WITH INDICIA RECORDING MEANS

(71) Applicants: Michael Moran, Milford, MI (US); Melissa Moran, Milford, MI (US)

(72) Inventors: Michael Moran, Milford, MI (US); Melissa Moran, Milford, MI (US)

(21) Appl. No.: 17/534,505

(22) Filed: Nov. 24, 2021

Related U.S. Application Data
(60) Provisional application No. 63/120,296, filed on Dec. 2, 2020.

(51) Int. Cl. G09F 3/02

(52) U.S. Cl. CPC G09F 3/02; G09F 2003/0272; G09F 2003/0216; G09F 2003/023

(57) ABSTRACT

An applied top or liner for use with a chest freezer lid, including a body adapted to engage against at least an upper surface of the lid. The body further includes an indicia writeable surface for permitting a user to record contents contained within a main body the freezer. The body further exhibits a tray shape with interconnected sides for engaging against opposing surfaces of the lid. The body can be constructed of any fabric or thermoplastic composite laminate. Either of adhesives or rare earth magnets can be used for securing the top to the freezer lid, such that the lid can be removable for cleaning, sanitizing or alteration.

### CROSS REFERENCE TO RELATED APPLICATIONS

The present application claims the priority of U.S. Ser. No. 63/120,296 filed Dec. 2, 2020.

### FIELD OF THE INVENTION

The present invention relates generally to an applied top for a chest style freezer. More particularly, the present invention discloses an attachable top or liner for use with an exterior of chest freezer lid which includes indicia recording means to register the contents of the freezer to avoid the necessity of the user having to open the freezer to determine contents contained therein apart from removing.

### BACKGROUND OF THE INVENTION

The prior art is documented with examples of coverings or preparation surfaces associated with refrigeration equipment. A first example is depicted in U.S. Pat. No. 9,989,299 to Ballard which discloses a cooler with a top food preparation surface. U.S. Pat. No. 4,896,785, to Sodervall, teaches a glass cover or lid for a chest freezer which permits good contained therein to be viewed through the glass cover. U.S. Design Pat. No. 396,048 to Meehan teaches a similar merchandise cooler with a transparent cover. U.S. Pat. No. 4,400,951 to Cherry further discloses a combination food freezer and dining table.

### SUMMARY OF THE INVENTION

The present invention discloses an attachable top or liner for use with a pivotally attached lid of a conventional chest freezer. The cover can be provided as a generally flat or shallow rectangular tray shaped profile of any suitable material, such as without limitation including a durable rubber, thermoplastic or multi-layer laminate having a specified degree of flexibility in order to permit the cover to be attached to or over the lid and to remain in place during opening and closing of the lid. This can further include the edges of the lid being constructed with attachment materials which adhere the cover in place during use. Without limitation, the attachment materials can include the use of adhesives or magnets.

The cover material is of an indicia writeable and erasable material, such that a dry erase marker or the like provided for recording on the cover the contained contents within the freezer. In this manner, the necessity is eliminated of the user opening the lid in order to conduct any prolonged search as to the freezer contents, thus preventing build-up of frost and exposure of the contents to the ambient atmosphere.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective of a chest freezer lid liner according to one non-limiting embodiment of the present invention;

FIG. 2 is an environmental view depicting the attachable chest freezer lid according to a first operational application in which the lid is positioned in a closed position;

FIG. 3 is a succeeding view to FIG. 2 depicting the chest freezer lid in an upwardly pivoted open position and by which the indicia recordable cover remains attached thereto during access to the freezer interior contents;

FIG. 4 is a cutaway taken along line 4-4 of FIG. 1 and depicting a peel away strip and adhesive backing for securing an underside of the liner to the lid; and

FIG. 5 is a similar illustration to FIG. 4 of an alternate configuration of the present invention depicting a magnet secured to an underside location of the liner according to a further non-limiting embodiment.

### DETAILED DESCRIPTION OF THE PREFERRED EMBODIMENTS

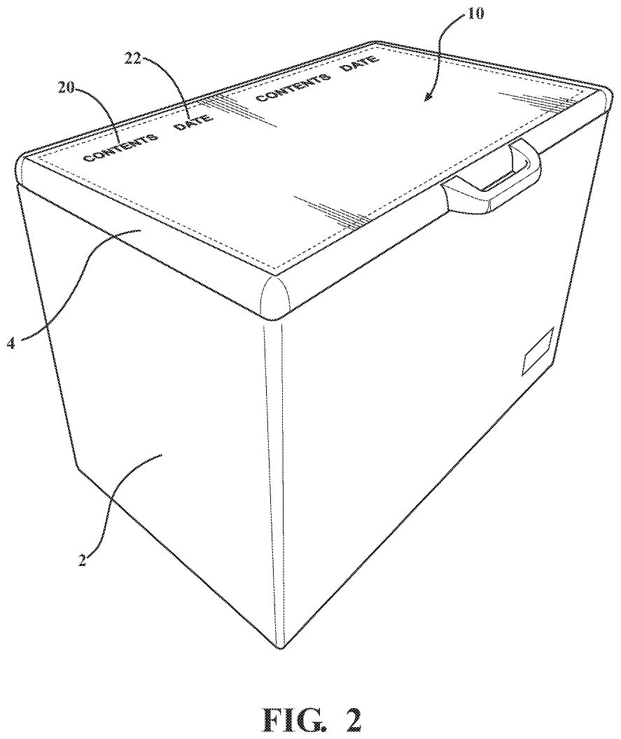

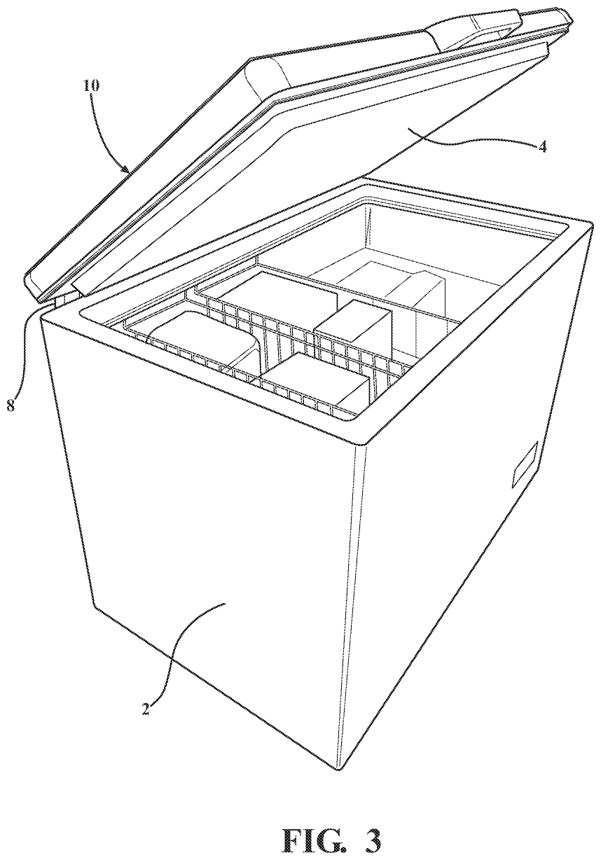

With reference to the attached drawings, the present invention discloses an attachable liner or top for use with an exterior of a chest freezer 2 (see FIGS. 2-3) having a pivotally attached lid 4 (see as shown in FIGS. 2-3), and which includes indicia recording means to register the contents of the freezer and thereby to avoid the necessity of the user having to open the freezer to determine contents contained therein.

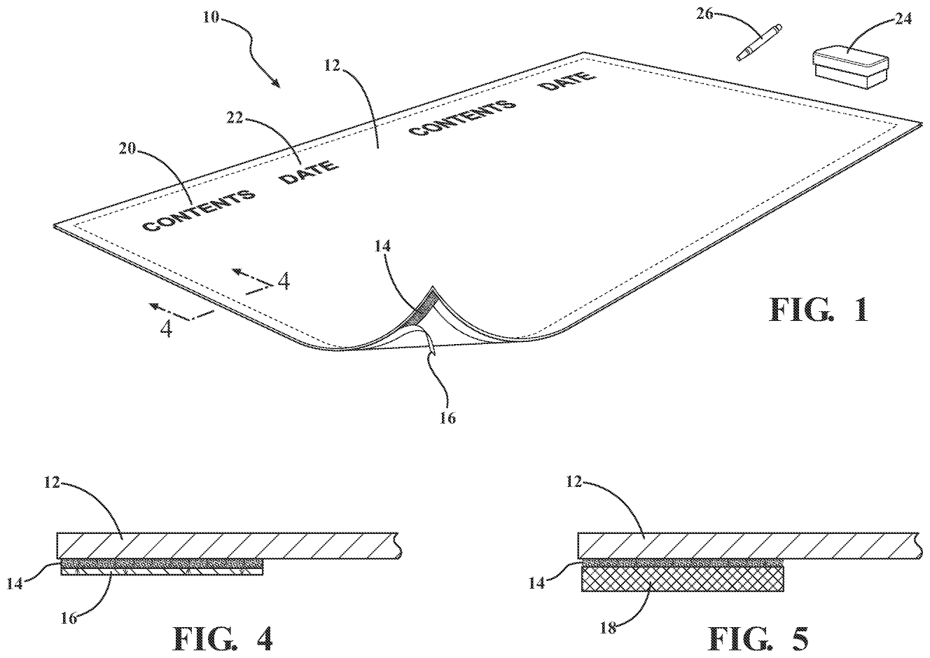

FIG. 1 presents a perspective illustration, generally at 10, of a liner or attachable top according to one non-limiting embodiment of the present invention. As previously noted, the liner 10 is sized based on the dimensions of the pivotally attached freezer lid, and, as further referenced in each of the closed and opened environmental views of FIGS. 2-3 can, without limitation, exhibit a shallow three dimensional shape, typically a rectangular tray with a base surface.

The liner includes any of a flexible, semi-rigid or rigid body 12, and can also include any of a single or multi-ply construction. It is also envisioned that the liner body can be provided as a single flattened sheet of material having any desired thickness, such as which can be adhesively applied to the opposing top surface of the freezer lid 12 in multiple commonly understood (and none permanent) methods.

In this fashion, the liner 10 is secured over the exterior of the top of the lid 4 without detaching during opening and closing and further without impacting the hinged edge location (see further at 8 in FIG. 3) established between the lid and main body of the chest freezer 2. As further best depicted in FIG. 3, the chest freezer exhibits the main body at 14 to which the lid 12 is pivotally attached and which, upon opening, provides access to the interior contents (at 6 in FIG. 3) of the freezer.

Without limitation, the applied top or liner 10 as best shown in FIG. 1 includes a main rectangular shaped flexible body 12 which can be constructed of any suitable material which can include any of an insulating rubber, thermoplastic or multi-layer laminate composite. The liner 10 can further exhibit any suitable thickness or specific material composition and can be sized or dimensioned so that it is adhesively, magnetically, frictionally or resistively fitted atop the lid 4 of the chest freezer 2. Alternatively, the liner can include additional side extending flaps (not shown) along the interconnecting edges of the freezer lid for providing another possible option for securing the liner atop the lid 4.

As shown in the cutaway of FIG. 4, any of a single or dual sided adhesive 14 is applied along an underside edge perimeter of the flexible liner 12 and over which is attached a peel away tape or strip 16. Upon removal of the strip 16, the liner is secured atop the freezer lid 4 as shown in FIG. 2 to affix the liner in place.

Alternatively, and is shown in FIG. 5, an attachment material includes such as rare earth magnets 16 which can be either secured to an underside of the liner body via adhesives (see again at 14). The present invention envisions any of a single elongated attachable magnet or the use of plural and spaced apart magnets 16 positioned between the opposing edge locations of the freezer lid and applied top or liner for adhering to the freezer lid during normal use, including opening and closing of the lid as well as placement of articles upon the liner body 12. Alternatively, and in the instance of a non-magnetically adhering lid 4, opposing and inter-adhering pluralities of magnets can be provided (a first plurality attached to the liner as shown and a second secured to aligning locations of the freezer lid) for securing the liner. Accordingly, the applied liner of the present invention remains with the freezer lid during use and contrary to prior art coverings which need to be removed prior to opening of the freezer lid.

The material surface of the liner 10 can further be optimized to permit the user to record, such as through the use of a writeable indicia not limited to a dry erase marker or the like, the contents of the freezer. As further shown in FIGS. 1-2, the liner can include pre-printed indicia such as CONTENTS 20 and DATE 22 located along the top of the liner and which permit the user to utilize such as a dry erase marker for entering items placed into the chest freezer 2. Also shown is a dry eraser 24 and dry marker 26 (again FIG. 1) which can be utilized for

In this fashion, the user can avoid opening the freezer for any prolonged period of time, such as in instances in which the user must inspect the freezer contents with resultant frost buildup and attendant energy losses resulting from exposing the contents to the ambient atmosphere outside of the freezer.

Additional features include the liner being removable for cleaning and/or sanitizing, as well as being serviceable for alteration. The present cover, by its design, provides for active interface and support to the freezer user/owner for normal function and operation of the freezer. The cover further operates as a storage shelf for placement of items atop the freezer and to prevent damage to the freezer lid or top, and not limited to protecting the OEM materials from scratches, dents, discoloration and damage.

Aspects of the present invention include manufacturing the protective cover from multiple high-quality materials serving potentially different needs and which are attached to the freezer top in such as one of the manners previously described in order to protect the OEM material from scratches, dents, discoloration or other damage. The surface-most ply or layer of the liner is further understood to include any specialized material which permits the user to indicia record the contents of the freezer and (optionally) the interior location where the items are stored in the freezer. This further permits the listed inventory of contents to be easily revised as items are removed.

Additional advantages of exterior listing of the freezer contents include avoiding prolonged searches with the freezer lid open which can result in frost build up among other detrimental aspects of exposing the interior contents to ambient conditions. Other aspects and advantages include the ability to detach or remove the liner for ease of cleaning or sanitizing for servicing/altering. The attachable liner of the present invention is further understood to provide an active interfacing article for use by the owner in cataloging/recording and storing freezer-able items within the chest freezer and, when closed, to permit the lid 4 of the freezer to be used as a storage shelf for placement thereupon of other items.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. An liner for use with a chest freezer lid, comprising:
a body adapted to engage against at least an upper surface of the lid; and
said body further including an indicia writeable surface for permitting a user to record contents contained within a main body the freezer.

2. The invention according to claim 1, said liner further comprising any of a single or multi-ply flexible body constructed of any of a fabric or thermoplastic composite laminate.

3. The invention according to claim 1, further comprising a dry marker and a dry eraser for recording and revising the contents upon said the indicia writeable surface.

4. The invention according to claim 1, further comprising an attachment material configured between opposing edges of the freezer lid and said liner.

5. The invention according to claim 4, said attachment material further comprising either of a single or dual sided adhesive affixed to an underside surface of said body.

6. The invention according to claim 4, said attachment material further comprising one or more magnets affixed to surface locations of said body.

7. The invention according to claim 1, further comprising said body being removable from the freezer lid for any of cleaning, sanitizing or alteration.

8. The invention according to claim 1, further comprising said liner body providing storage support when items are adapted to being placed upon the lid.
